(19) United States
(12) Patent Application Publication
(10) Pub. No.: US 2012/0048312 A1
(43) Pub. Date: Mar. 1, 2012

(54) PIPE CLEANING ASSEMBLY

(75) Inventors: Harold W. Wilson, Beckville, TX (US); William S. Jones, LaFayette, LA (US); Joseph Nathan Wilson, Beckville, TX (US); Weldon Wilson, Kilgore, TX (US)

(73) Assignee: Slider LLC, Beckville, TX (US)

(21) Appl. No.: 12/868,677

(22) Filed: Aug. 25, 2010

(51) Int. Cl. B08B 9/00; B08B 3/00

(52) U.S. Cl. 134/166 C; 134/22.12

(57) ABSTRACT

A pipe cleaning assembly includes a main shaft defining an inner bore aligned along a first axis, the inner bore being able to couple in fluid communication with coiled tubing. A slide shaft is disposed around the main shaft, the slide shaft having a forward end, a rear end, and a plurality of fluid pathways. Each of the fluid pathways is in fluid communication between the forward end of the slide shaft and the read end of the slide shaft. Each of the fluid pathways has a forward end able to direct fluid toward an inner surface of a pipe. The slide shaft is able to slide along the main shaft between a first position and a second position, in the direction of the first axis. The first position permits fluid flow through the plurality of fluid pathways, from the rear end of the slide shaft to the forward end of the slide shaft. The second position restricts fluid flow through the plurality of fluid pathways, from the forward end of the slide shaft to the rear end of the slide shaft.

### TECHNICAL FIELD

The present invention relates generally to the field of natural resource development and, more particularly, to a system and method for improved maintenance of equipment.

### BACKGROUND

Modern natural resource exploration and production techniques typically include use of long cylindrical passages such as vertical wells, horizontal wells, and pipelines. These cylindrical passages are frequently used to move natural resources, such as oil, gas, and other fluids, from one location to another. Especially at the exploration and production stages, the passages that serve to move a natural resource from its discovered location in the Earth must reach that location. That is, the pipes must go to where the resources are, which includes locations that are difficult to reach, such as deepwater undersea and deep downhole locations.

More generally, drilling for and producing subterranean oil and gas deposits and seeking out other energy sources frequently requires drilling vertical, horizontal, and/or curved holes. Such drilled holes can be part of a well, pipe line, production line, drill pipe, or other hole, for example, as desired by the operators. Fixed-diameter, elongated tubes, pipes, and/or segments inserted into the drilled holes provide stable passages through which the natural resources can be extracted.

At any stage of this process, blockages in the passages and/or holes can form. In part because of the location of the passages, accessing and clearing blockages can be difficult, costly and time consuming. Occasionally, these blockages reduce fluid flow through the passages, but may not require the operation to be shut down. Eventually, however, a blockage develops that does require the operation be shut down so that the blockage can be removed.

Generally, most approaches to clearing blockages use special cleaning tools inside the pipe or open hole. Thus, it is often necessary to insert a tube having a diameter smaller than the diameter of the drill, production pipe, or open hole, in order to remove or destroy the blockages that have formed in the pipe/open hole. Typical pipe cleaning operations now use continuous tubing, referred to as “coiled tubing”, attached to a “pig” or other tool, which is fed through the pipe/hole to the blockage.

There are numerous techniques well-known to those skilled in the art for maneuvering a pig and coiled tubing to a blockage. For example, the tubing is usually relatively flexible injected-type tubing, having a continuous length, which is rolled off of a large reel as it is inserted into the pipe/hole. Various tools can be connected to the working end of the tubing, to perform whatever task is necessary.

But the known methods suffer from various drawbacks. For example, large forces are often necessary to insert and withdraw thousands of feet or more of steel, tubing, tools, etc. into a pipe/hole, especially as that pipe/hole may already be filled with fluid, resources, and/or other materials. Many modern cleaning tools cannot be easily maneuvered inside the pipe/hole and therefore require additional force to operate. Depending on the nature of the blockage, this additional force may be the difference between a successful and an unsuccessful cleaning operation.

As such, some techniques have been developed that apply variations in pressure to maneuver the cleaning tool and tubing within the pipe/hole. In many of these techniques, additional tool components are required, which increases the cost of the cleaning tool, as well as increases the number of components that are subject to breakage and/or jamming. In some cases, a broken or jammed cleaning tool requires the entire length of tubing to be withdrawn from the pipe, the tool replaced, and the replacement tool sent back down to the working area.

These issues frequently cause costly delay and can introduce safety and reliability issues, as well as increasing wear and tear on the equipment. Further, typical cleaning tools cannot be easily converted for use in a variety of pipe/hole diameters, and do not allow for a bull bore return throughout the pipe/hole.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

In a general aspect of the invention, a pipe cleaning assembly includes a main shaft defining an inner bore aligned along a first axis, the inner bore being able to couple in fluid communication with coiled tubing. A slide shaft is disposed around the main shaft, the slide shaft having a forward end, a rear end, and a plurality of fluid pathways. Each of the fluid pathways is in fluid communication between the forward end of the slide shaft and the read end of the slide shaft. Each of the fluid pathways has a forward end able to direct fluid toward an inner surface of a pipe. The slide shaft is able to slide along the main shaft between a first position and a second position, in the direction of the first axis. The first position permits fluid flow through the plurality of fluid pathways, from the rear end of the slide shaft to the forward end of the slide shaft. The second position restricts fluid flow through the plurality of fluid pathways, from the forward end of the slide shaft to the rear end of the slide shaft.

In a preferred embodiment, the pipe cleaning assembly includes a cup disposed around the slide shaft, the cup having a flexible outer rim. In another preferred embodiment, the pipe cleaning assembly further comprises a first cup of a plurality of cups, the first cup being disposed around the slide shaft. Each of the plurality of cups has a flexible outer rim and each flexible outer rim is configured to make contact with a pipe inner surface, the pipe inner surface having a predetermined diameter.

In another preferred embodiment, the pipe cleaning assembly further comprises a cup disposed around the slide shaft, the cup having a forward slot, the forward slot configured to seat an o-ring. In another preferred embodiment, the pipe cleaning assembly further comprises a cup disposed around the slide shaft, the cup having a rear slot, the rear slot being configured to seat a retaining seal.

In another preferred embodiment, the pipe cleaning assembly further comprises a first cup disposed around the slide shaft and a second cup disposed around the slide shaft. A cup spacer is also disposed around the slide shaft, the cup spacer being configured to maintain a minimum spacing between the first cup and the second cup. In another preferred embodiment, the pipe cleaning assembly further comprises a first cup disposed around the slide shaft and a second cup disposed around the slide shaft. A cup spacer is also disposed around the slide shaft, the cup spacer being configured to maintain a minimum spacing between the first cup and the second cup, and the cup spacer having a slot configured to seat an o-ring.

In another preferred embodiment, the pipe cleaning assembly further comprises a retaining nut able to couple to the main shaft. The retaining nut is further able to prevent the slide shaft from moving past the first position in the direction away from the second position. In another preferred embodiment, the pipe cleaning assembly further comprises a retaining nut able to couple to the main shaft, the retaining nut being further able to prevent the slide shaft from moving past the first position in the direction away from the second position. A blade couples to the retaining nut. The blade is able to break apart matter passing into the forward end of the main shaft inner bore.

In another general aspect of the invention, a method of cleaning a pipe includes disposing a pipe cleaning assembly within a pipe, the pipe having an inner surface. The pipe cleaning assembly includes a main shaft defining an inner bore aligned along a first axis, the inner bore being able to couple in fluid communication with coiled tubing. A slide shaft is disposed around the main shaft, the slide shaft having a forward end, a rear end, and a plurality of fluid pathways. Each of the fluid pathways is in fluid communication between the forward end of the slide shaft and the read end of the slide shaft. Each of the fluid pathways has a forward end able to direct fluid toward an inner surface of a pipe. The slide shaft is able to slide along the main shaft between a first position and a second position, in the direction of the first axis. The first position permits fluid flow through the plurality of fluid pathways, from the rear end of the slide shaft to the forward end of the slide shaft. The second position restricts fluid flow through the plurality of fluid pathways, from the forward end of the slide shaft to the rear end of the slide shaft. The method also includes operating the pipe cleaning assembly in the first position to direct fluid flow to the pipe inner surface.

In a preferred embodiment, the pipe cleaning assembly includes a cup disposed around the slide shaft, the cup having a flexible outer rim. In another preferred embodiment, the pipe cleaning assembly further comprises a first cup of a plurality of cups, the first cup being disposed around the slide shaft. Each of the plurality of cups has a flexible outer rim and each flexible outer rim is configured to make contact with a pipe inner surface, the pipe inner surface having a predetermined diameter.

In another preferred embodiment, the pipe cleaning assembly further comprises a cup disposed around the slide shaft, the cup having a forward slot, the forward slot configured to seat an o-ring. In another preferred embodiment, the pipe cleaning assembly further comprises a cup disposed around the slide shaft, the cup having a rear slot, the rear slot being configured to seat a retaining seal.

In another preferred embodiment, the pipe cleaning assembly further comprises a first cup disposed around the slide shaft and a second cup disposed around the slide shaft. A cup spacer is also disposed around the slide shaft, the cup spacer being configured to maintain a minimum spacing between the first cup and the second cup. In another preferred embodiment, the pipe cleaning assembly further comprises a first cup disposed around the slide shaft and a second cup disposed around the slide shaft. A cup spacer is also disposed around the slide shaft, the cup spacer being configured to maintain a minimum spacing between the first cup and the second cup, and the cup spacer having a slot configured to seat an o-ring.

In another preferred embodiment, the pipe cleaning assembly further comprises a retaining nut able to couple to the main shaft. The retaining nut is further able to prevent the slide shaft from moving past the first position in the direction away from the second position. In another preferred embodiment, the pipe cleaning assembly further comprises a retaining nut able to couple to the main shaft, the retaining nut being further able to prevent the slide shaft from moving past the first position in the direction away from the second position. A blade couples to the retaining nut. The blade is able to break apart matter passing into the forward end of the main shaft inner bore.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 is a block diagram illustrating a pipe cleaning assembly in accordance with a preferred embodiment;

FIG. 2 is a cutaway diagram illustrating a pipe cleaning assembly in accordance with a preferred embodiment;

FIG. 3 is a cutaway diagram illustrating a pipe cleaning assembly in operation in a first position, in accordance with a preferred embodiment;

FIG. 4 is a cutaway diagram illustrating a pipe cleaning assembly in operation in a second position, in accordance with a preferred embodiment;

FIG. 5 is an exploded view of a pipe cleaning assembly, in accordance with a preferred embodiment;

FIG. 6 is an exploded, cutaway view of a pipe cleaning assembly, in accordance with a preferred embodiment;

FIG. 7 is an end-on view of a pipe cleaning assembly, in accordance with a preferred embodiment;

FIG. 8 is a side view and end-on view of a cup spacer, in accordance with a preferred embodiment;

FIG. 9 is a side view and an end-on view of a retaining nut, in accordance with a preferred embodiment;

FIG. 10 is a cutaway side view and an end-on view of a cup, in accordance with a preferred embodiment; and

FIG. 11 illustrates a high-level flow diagram depicting logical operational steps of an improved pipe cleaning method, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope of the invention. In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail.

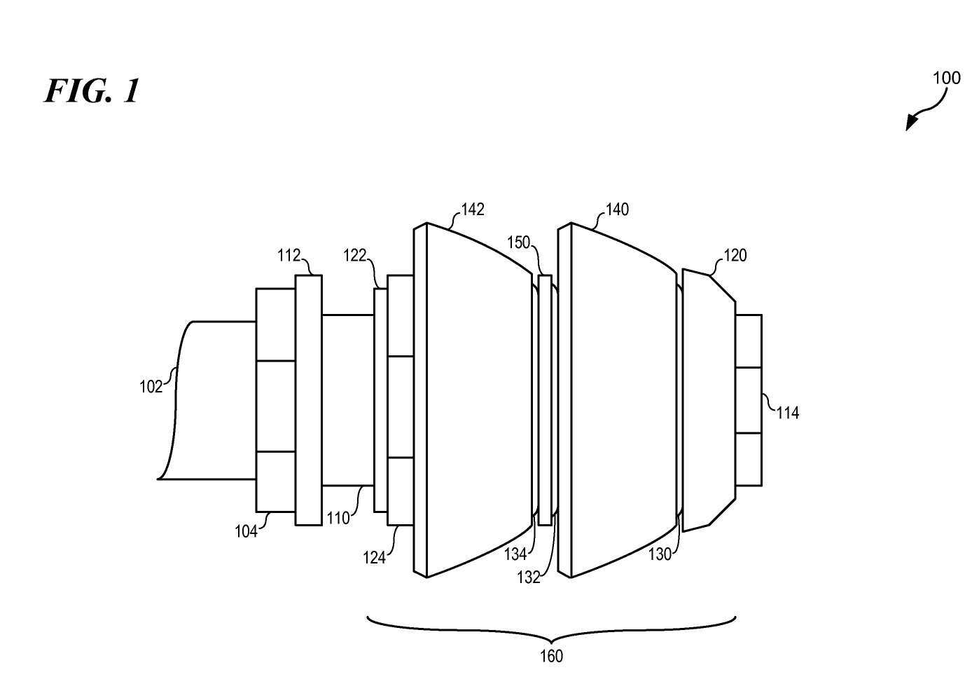

FIG. 1 is a high-level diagram illustrating certain components of a system 100 for improved pipe cleaning, in accordance with a preferred embodiment of the present invention. Generally, system 100 includes a pipe cleaning assembly, described in more detail below, which is coupled to tubing 102. In the illustrated embodiment, tubing 102 is otherwise conventional coiled tubing, such as the coiled tubing employed in subterranean oil and gas exploration, for example.

Generally, the pipe cleaning assembly of system 100 includes a sliding member 160 coupled to a main shaft 110. As described in more detail below, sliding member 160 moves back and forth along main shaft 110 between two primary positions. Depending on the position, system 100 operates to clean the inside of a pipe as it travels forward through the pipe, or to help propel the system 100 backwards as it travels backward through the pipe, as described in more detail below.

In the illustrated embodiment, a main shaft 110 couples to tubing 102. Specifically, in the illustrated embodiment, coupling nut 104 couples main shaft 110 to tubing 102. Generally, as described in more detail below, main shaft 110 and tubing 102 are coupled in fluid communication. As used herein, components coupled in “fluid communication” are coupled such that fluid can move between the components.

In the illustrated embodiment, sliding member 160 is disposed about main shaft 110. In the illustrated embodiment, sliding member 160 includes a slide shaft 120, a pair of cups 140 and 142, and a seal retainer 124. Generally, as described in more detail below, slide shaft 120 is a cylinder able to move along the axis of main shaft 110. As described in more detail below, slide shaft 120 includes a plurality of fluid pathways (not shown).

Generally, slide shaft 120 is able to move back and forth from one position to another, along the length of main shaft 110. In the illustrated embodiment, a rear retainer 112 establishes one position, preventing slide shaft 120 from passing beyond rear retainer 112 toward the tubing 102. Similarly, a retaining nut 114 establishes another position, preventing slide shaft 120 from passing beyond retaining nut 114 away from tubing 102.

As described above, in the illustrated embodiment, sliding member 160 also includes cups 140 and 142. Generally, cups 140 and 142 are semi-conical members disposed around slide shaft 120, as described in more detail below. In one embodiment, cups 140 and 142 are constructed of elastomeric material, plastic, and/or other suitable material. In the illustrated embodiment, cups 140 and 142 form an outer diameter of sliding member 160. As described in more detail below, in one embodiment, cups 140 and 142 are configured to be easy to replace, with a diameter corresponding to the diameter of the pipe system 100 will be used to clean.

Generally, certain other components of sliding member 160 can be configured to orient and secure cups 140 and 142. For example, as shown in the illustrated embodiment, a number of o-rings are also disposed about slide shaft 120. Specifically, in the illustrated embodiment, o-ring 130 seats cup 140 against the forward part of shaft 120. Similarly, o-rings 132 and 134 seat cups 140 and 142 against a cup space 150.

Generally, cup spacer 150 is configured to maintain a predetermined spacing between cups 140 and 142. As described in more detail below, the dimensions of cup spacer 150 can be selected based on the size of cups 140 and 142. As such, in one embodiment, cup spacer 150 and cups 140 and 142 are configured with a diameter corresponding to the diameter of the pipe system 100 will be used to clean.

Additionally, in the illustrated embodiment, cups 140 and 142 are secured to slide shaft 120 by a seal retainer 124. As illustrated, seal retainer 124 couples to a threaded end 122 of slide shaft 120 and seats abutting cup 142. As described in more detail below, in one embodiment, sliding member 160 can be easily reconfigured with different cups 140 and 142 by removing seal retainer 124, exchanging the cups 140 and/or 142 with the desired cups, and re-securing seal retainer 124.

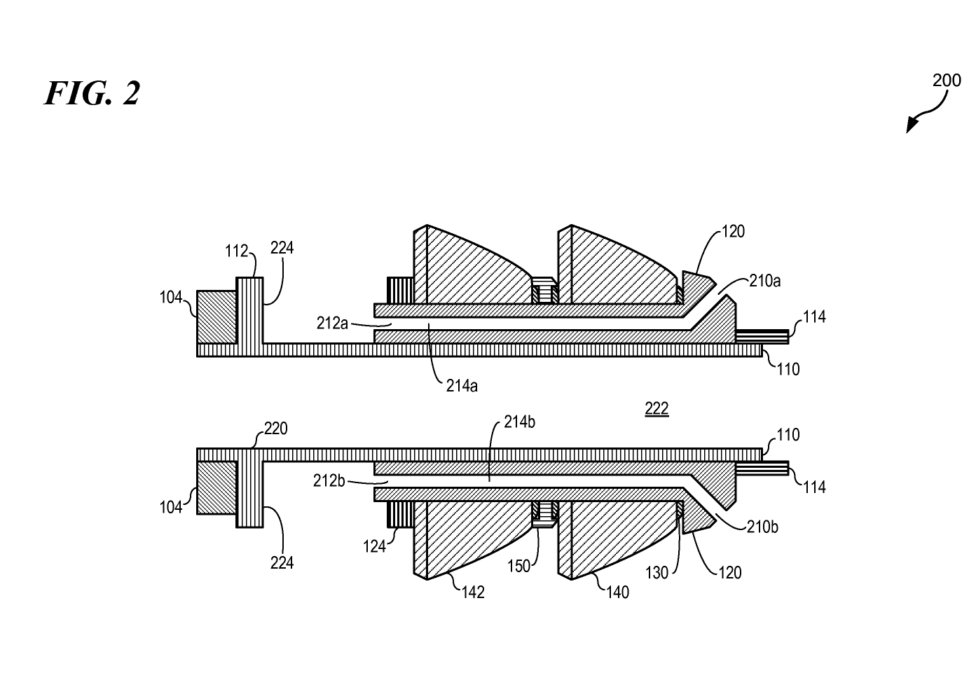

FIG. 2 is a cutaway view of the pipe cleaning assembly of FIG. 1. Specifically, FIG. 2 shows a system 200, which includes a slide shaft 120 disposed about a main shaft 110. As shown in the illustrated embodiment, main shaft 110 includes an inner diameter 220 that defines an inner bore 222. Additionally, in the illustrated embodiment, main shaft 110 includes a rear retaining surface 224. As described in more detail below, in one embodiment, rear retaining surface 224 is configured to prevent slide shaft 120 from moving beyond rear stop 112. In one embodiment, slide shaft 120 is positioned in a rear position when slide shaft 120 is positioned adjacent to rear retaining surface 224.

As described above, system 200 also includes a retaining nut 114. As described in more detail below, in one embodiment, retaining nut 114 is configured to prevent slide shaft 120 from moving beyond retaining nut 114. In one embodiment, slide shaft 120 is positioned in a forward position when slide shaft 120 is positioned adjacent to retaining nut 114.

In the illustrated embodiment, system 200 also includes a slide shaft 120 disposed about the main shaft 110. In the illustrated embodiment, slide shaft 120 includes a plurality of fluid pathways. As shown, each fluid pathway includes a forward end and a rear end. As described in more detail below, in one embodiment, the forward end is configured to direct fluid toward the inner surface of a pipe/hole that is being cleaned.

In the illustrated embodiment, slide shaft 120 is shown with two fluid pathways. As described in more detail below, slide shaft 120 can be configured with a plurality of fluid pathways. In the illustrated embodiment, slide shaft 120 includes a forward pathway section 210a in fluid communication with a rear pathway section 212a, forming a fluid pathway 214a. Similarly, slide shaft 120 includes a forward pathway section 210b in fluid communication with a rear pathway section 212b, forming a fluid pathway 214b. As described in more detail below, fluid passing along fluid pathways 214a and 214b can be manipulated to remove blockages and debris in a pipe/hole.

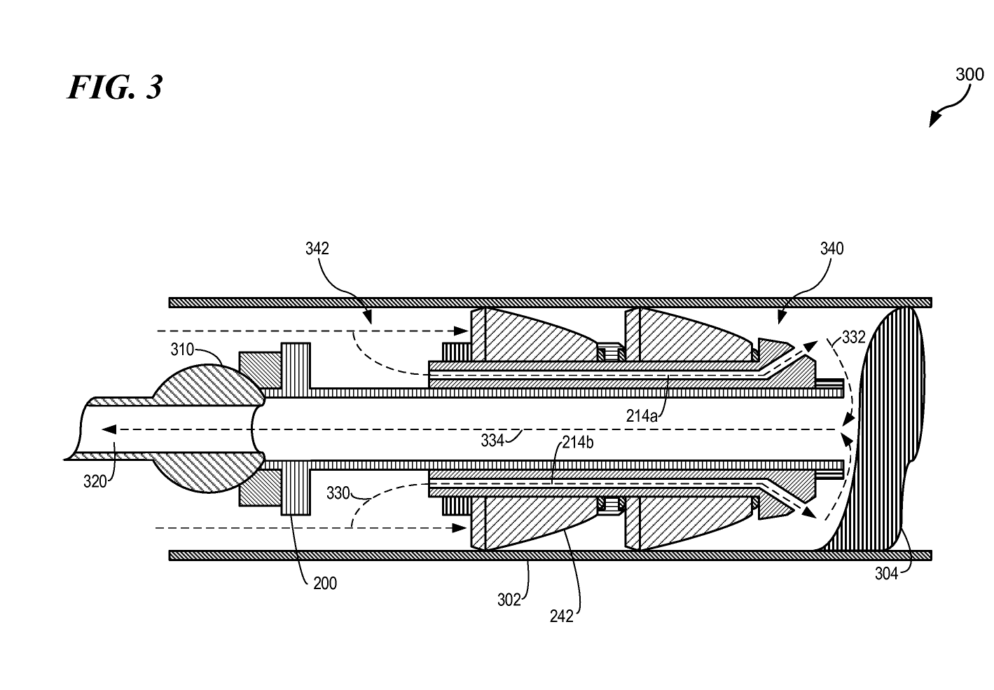

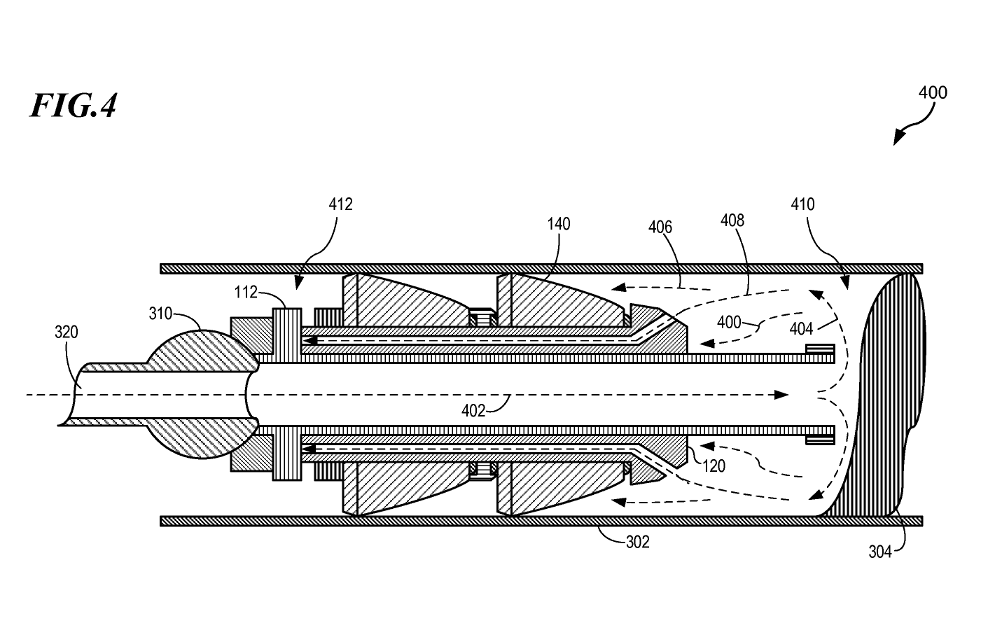

FIGS. 3 and 4 illustrate these pathways in operation. FIG. 3 illustrates a pipe cleaning assembly of FIGS. 1 and 2, in a forward position. Generally, in this configuration, the slide shaft is oriented at or near the extreme forward position of the main shaft. As described above, in one embodiment, a retaining nut prevents the slide shaft form moving off of the main shaft.

In the illustrated embodiment, a pipe cleaning assembly 200 is configured for forward motion within pipe 302 towards blockage 304. Generally, pipe 302 can be a pipeline, such as a down hole tubular, a surface pipeline, a subsea pipeline, an underground pipeline, or any other suitable pipeline. Additionally, in one embodiment, pipe 302 is a conventional residential or commercial building plumbing system, sewer system, or other suitable system. In the illustrated embodiment, pipe cleaning assembly 200 couples to an adapter 310 and coiled tubing 320. As shown, the pipe cleaning assembly is configured to clean pipe 302 and remove blockage 304.

Specifically, fluid pressure around (and outside of) coiled tubing 320 passes along arrows 330. As shown, the fluid exerts forward pressure on the rear of cup 242, which causes pipe cleaning assembly 200 to move forward through pipe 302. Additionally, the fluid passes from the rear of assembly 200 (near area 342) through the fluid pathways 214a and 214b. The fluid passes through the fluid pathways and leaves the pipe cleaning assembly 200 at the forward end of assembly 200 (near area 340).

One skilled in the art will notice that assembly 200 does not include a separate nozzle. Instead, the slide shaft fluid pathways direct fluid toward the internal wall of pipe 302 and blockage 304. As shown in the illustrated embodiment, the movement of fluid through the fluid pathway causes the fluid and debris to move as indicated by arrow 332, from area 340 into the inner bore of the main shaft. Further, because the main shaft is in fluid communication with the adapter 310 and tubing 320, the fluid and debris moves in the direction of arrow 334, through the main shaft and back through the coiled tubing 320.

Thus, FIG. 3 illustrates the operation of pipe cleaning assembly 200 in cleaning pipe 302 by application of fluid pressure around coiled tubing 320 and generally behind pipe cleaning assembly 200. FIG. 4 illustrates the operation of pipe cleaning assembly 200 in a second position, moving back out of pipe 302.

As shown in the illustrated embodiment, the slide shaft is positioned at or near the extreme rear position, with the end 222 of slide shaft 120 adjacent to the main shaft retainer 112. So configured, fluid pressure from the surface rig passes through (and inside) coiled tubing 320, through the main shaft inner bore, as indicated by arrow 402.

Fluid pressure passes from the main shaft inner bore out of the pipe cleaning assembly 200, as indicated by arrows 404 (near area 410). As shown, fluid pressure from area 410 travels as indicated by arrows 406, which exerts fluid force on the forward face of slide shaft 120 and cup 140. Additionally, as shown, fluid pressure from area 410 also travels as indicated by arrows 408, moving from the forward end of the fluid pathways to the rear end of the fluid pathways.

As illustrated, the rear end of slide shaft 120 is positioned adjacent to the main shaft retainer 112. So configured, fluid is mostly restricted from passage out of the rear end of the fluid pathways. As such, the fluid pressure exerted against main shaft retainer 112 tends to move main shaft 110 (and therefore the rest of pipe cleaning assembly 200) backwards through pipe 302. Additionally, in one embodiment, the seal between slide shaft 120 and main shaft 110 at shaft retainer 112 permits a small amount of fluid to pass, which encourages lubrication and assists in removing the pipe cleaning assembly 200 from pipe 302.

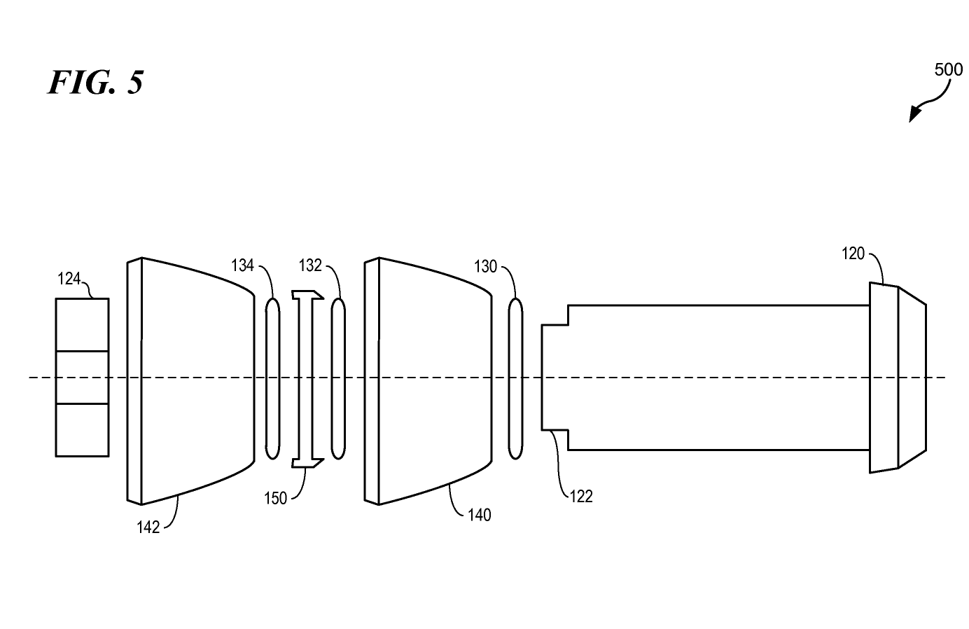

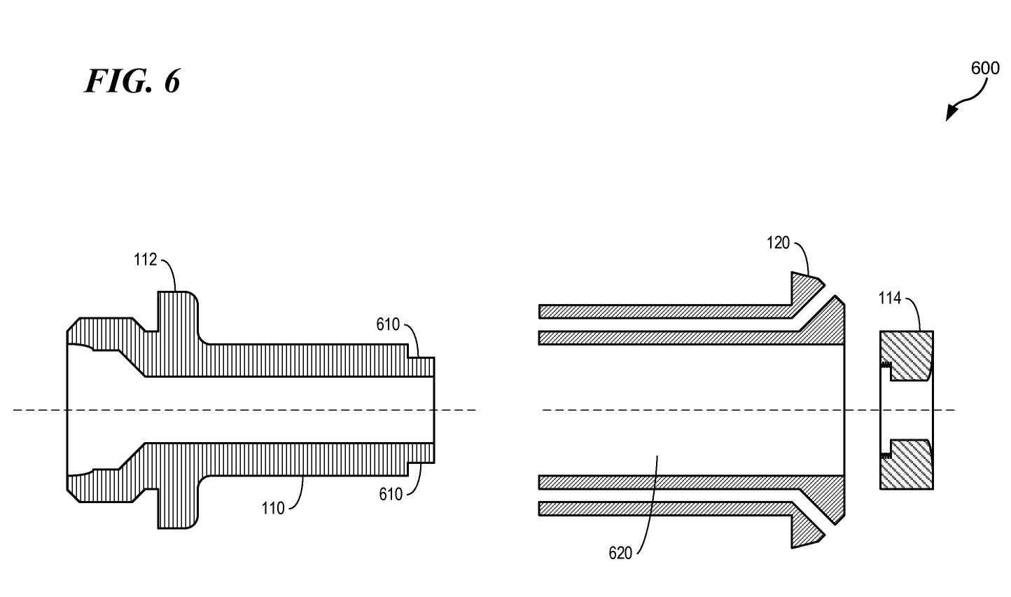

FIGS. 5 and 6 provide additional detail regarding the assembly of pipe cleaning assembly 200. Specifically, FIG. 5 illustrates an exploded view of a sliding member 500, in accordance with one embodiment. In the illustrated embodiment, sliding member 500 includes a slide shaft 120. In the illustrated embodiment, slide shaft 120 includes a rear end 122. In one embodiment, rear end 122 includes threads. In one embodiment, rear end 122 is configured with Acme threads. Generally, rear end 122 is configured to receive a seal retainer 124, which, as described in more detail below, retains various components that couple around and to slide shaft 120.

Specifically, sliding member 500 includes o-rings 130, 132, and 134, cups 140 and 142, and cup spacer 150. As shown in the illustrated embodiment, the components of sliding member 500 are assembled as indicated. For example, o-ring 130 seats cup 140 against a forward end of slide shaft 120. Similarly, o-rings 132 and 134 seat in cup spacer 150, which maintains a desired spacing between cups 140 and 142. As described above, sliding member 500 is thus configured to slide between a forward position and a rear position along main shaft 110.

FIG. 6 illustrates the attachment of slide shaft 120 and main shaft 110. Specifically, FIG. 6 is a cutaway view of a pipe cleaning assembly 600, in accordance with one embodiment. As illustrated, slide shaft 120 forms an inner bore 620, though which main shaft 110 passes. Generally, main shaft 110 couples slidably to slide shaft 120 such that slide shaft 120 is able to move along the axis of main shaft 110.

As shown, in the illustrated embodiment, main shaft 110 includes a threaded section 610. In one embodiment, threaded section 610 is configured with acme threads. Generally, main shaft 110 couples to a retaining nut 114 at threaded section 610. As described above, in one embodiment, retaining nut 114 prevents slide shaft 120 from moving beyond the end of main shaft 110. Similarly, in one embodiment, retainer 112 prevents slide shaft 120 from moving beyond the rear end of main shaft 110, as described above. Accordingly, so configured, slide shaft 120 is able to move from a forward position to a rear position, as described above.

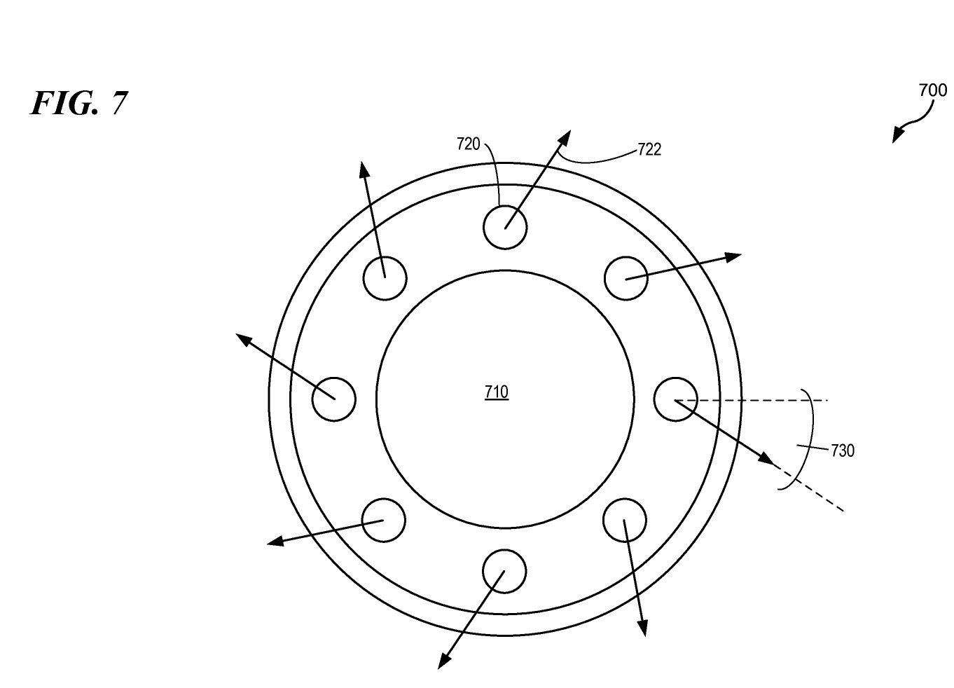

FIG. 7 is an end-on view of a slide shaft 700, in accordance with one embodiment. Specifically, in the illustrated embodiment, slide shaft 700 defines an inner bore 710. As described above, in one embodiment, inner bore 710 defines an area through which main shaft 110 couples.

Additionally, in one embodiment, slide shaft 700 includes a plurality of fluid pathways. In the illustrated embodiment, slide shaft 700 includes a plurality of fluid pathways, which each include a forward end 720. Generally, forward end 720 is configured to direct fluid flow from a fluid pathway toward a pipe/hole sidewall and/or a blockage, as described above. In the illustrated embodiment, each forward end 720 is configured to direct fluid flow in the direction generally indicated by arrow 722. Additionally, in the illustrated embodiment, arrow 722 is configured offset at an angle 730. One skilled in the art will understand that angle 730 can be configured to maximize fluid pressure against a pipe inner surface, so as to maximize cleaning of the pipe/hole.

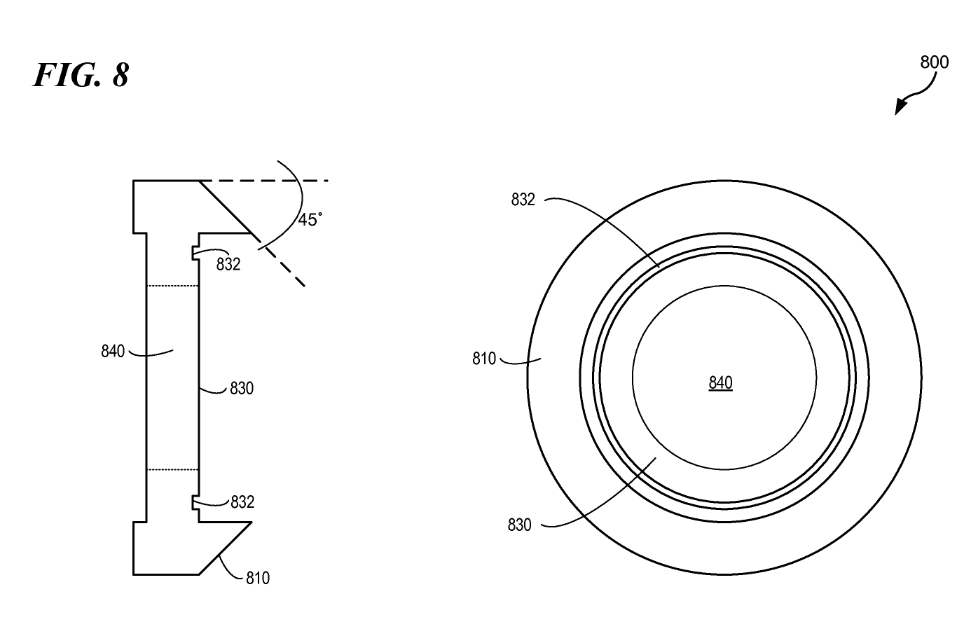

FIG. 8 illustrates a cup spacer 800 in accordance with one embodiment. Generally, cup spacer 800 forms an inner bore 840, which, as described above, is configured to be disposed around a slide shaft 120. In the illustrated embodiment, cup spacer 800 includes an outer annular surface 810 and an inner annular surface 830.

In the illustrated embodiment, outer annular surface 810 is configured with an angled face. In one embodiment the angled face is configured at a 45 degree angle. Generally, the particular angle of outer annular surface 810 can be configured to maximize fluid flow across outer annular surface 810.

In the illustrated embodiment, inner annular surface 830 includes a groove 832. Generally, groove 832 is configured to seat an o-ring. In one embodiment, groove 832 seats o-ring 130 of FIG. 1, for example. Generally, groove 832 seats an o-ring that abuts forward cup 140. One skilled in the art will understand that groove 832 can be configured to seat a variety of o-rings, so as to provide a seal between the o-ring and the particular cup 140 to which the o-ring abuts.

As described above, the pipe cleaning assembly can be configured with cups 140 of varying diameter. As such, in one embodiment, cup spacer 800 can also be configured with a diameter corresponding to the particular cups 140 and 142 between which cup spacer 800 sits.

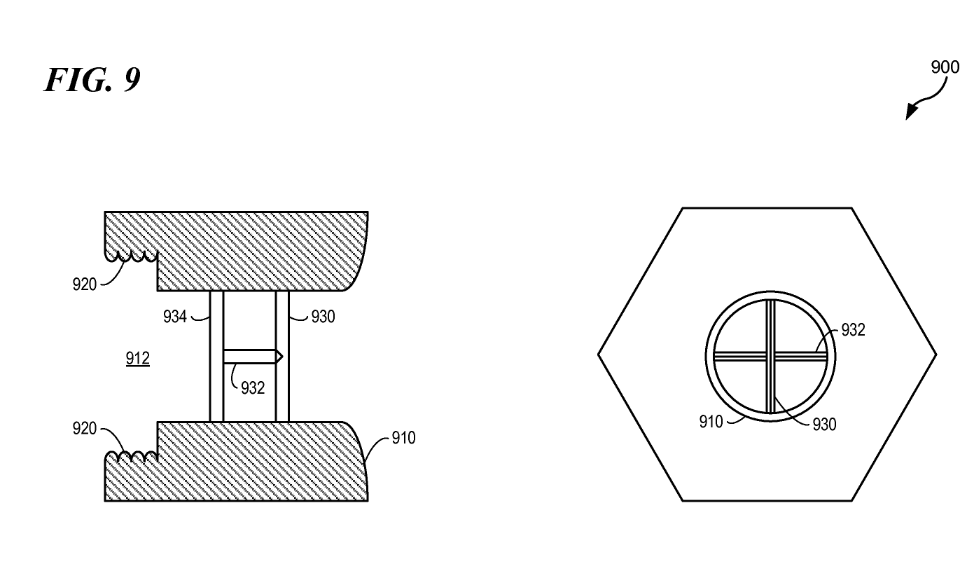

FIG. 9 illustrates an exemplary retaining nut, in accordance with one embodiment. Specifically, FIG. 9 illustrates a retaining nut 900 in a cutaway side view and an end-on view. In the illustrated embodiment, retaining nut 900 forms an inner bore 912. Generally, in one embodiment, inner bore 912 is configured to allow fluid to pass and is in fluid communication with the inner bore of main shaft 110.

As described above, in one embodiment, retaining nut 900 couples to main shaft 110. In the illustrated embodiment, retaining nut 900 includes a threaded recess 920. Generally, threaded recess 920 is configured to couple to a threaded section of a main shaft, such as threaded section 610, for example.

In one embodiment, retaining nut 900 also includes a plurality of debris blades. In the illustrated embodiment, retaining nut 900 includes a debris blade 930 and a debris blade 932, both coupled to a blade base 934. In one embodiment, debris blades 930 and 932 are constructed of rigid, durable steel. Generally, debris blades 930 and 932 are configured to break apart bits of debris so as to prevent debris above a particular size from passing into inner bore 912 (and thus into main shaft 110). As such, in the illustrated embodiment, retaining nut 900 is configured both to retain a sliding member disposed on a main shaft and to reduce the size of debris passing through the pipe cleaning assembly.

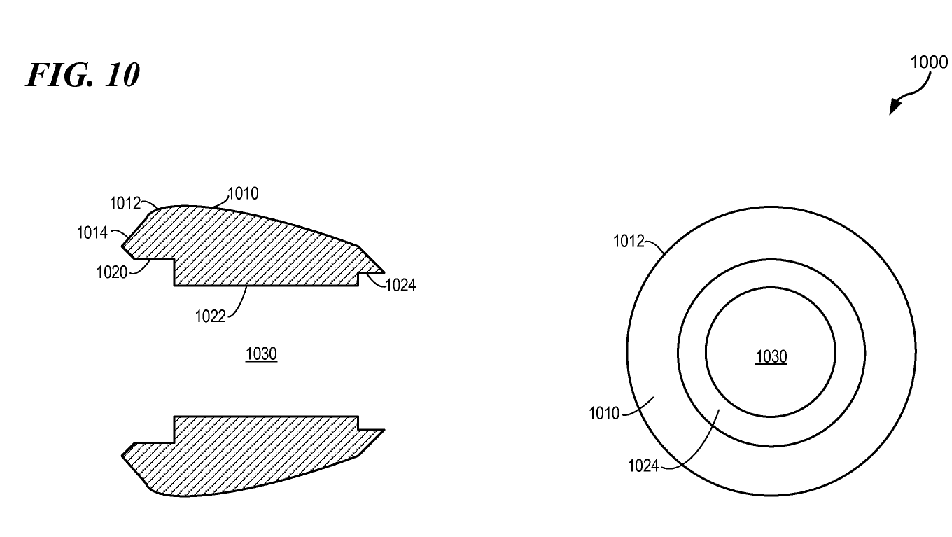

FIG. 10 illustrates an exemplary cup, in accordance with one embodiment. Specifically, FIG. 10 illustrates a cup 1000 in a cutaway side view and an end-on view. In the illustrated embodiment, cup 1000 forms an inner bore 1030. Generally, in one embodiment, inner bore 1030 is configured to fit around slide shaft 120, as described above.

Generally, in the illustrated embodiment, cup 1000 includes an angled surface 1010, an outer rim 1012, and a rear surface 1014. In the illustrated embodiment, angled surface 1010, outer rim 1012, and rear surface 1014 are generally configured to support the movement of pipe cleaning apparatus 200 through the pipe/hole in which it is deployed. For example, in one embodiment, outer rim 1012 is configured to correspond to the inner diameter of the pipe/hole in which it is deployed. Similarly, in the illustrated embodiment, cup 1000 is configured with an inner bore diameter 1022 configured to correspond to the outer diameter of the slide shaft 120 to which it couples.

Additionally, in the illustrated embodiment, cup 1000 also includes two notches 1020 and 1024. In the illustrated embodiment, notch 1020 is configured to seat a seal retainer 124. So configured, seal retainer 124, seated in notch 1020, secures cup 1000 in position on slide shaft 120. As such, cup 1000 remains in place on slide shaft 120, even as slide shaft 120 moves along main shaft 110.

Similarly, in the illustrated embodiment, notch 1024 is configured to seat an o-ring, such as o-ring 130 or o-ring 134, for example. So configured, o-ring 130, seated in notch 1024, secures cup 140 to the forward end of slide shaft 120, forming a seal that protects cup 140 during operation.

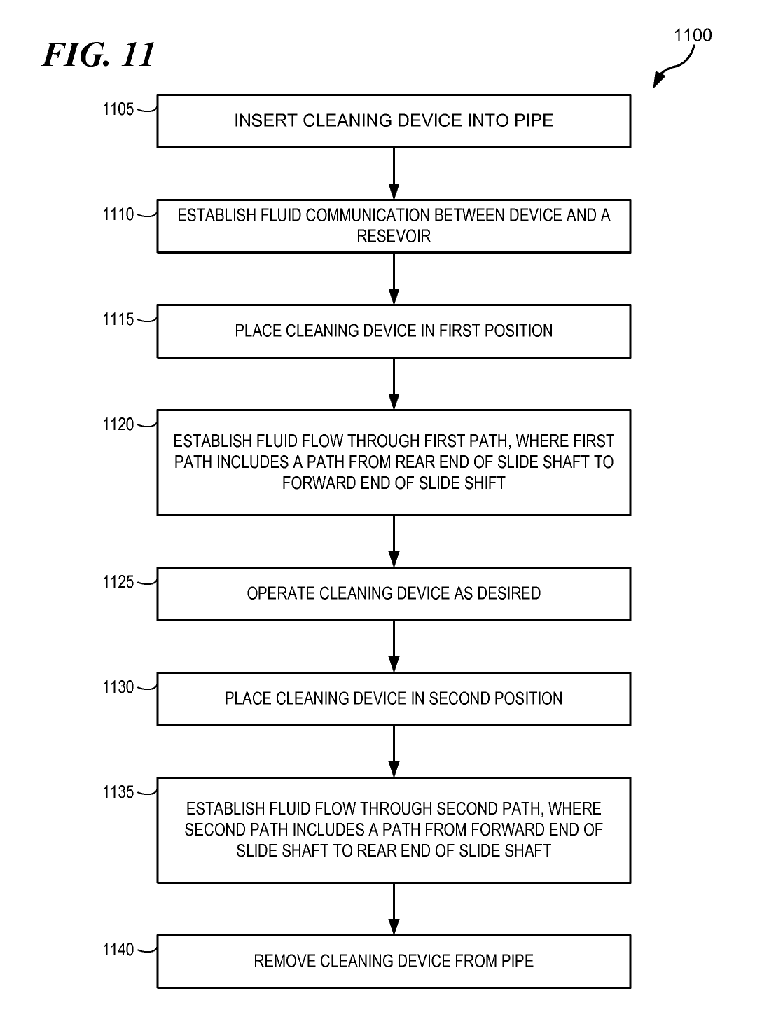

FIG. 11 is a flow diagram 1100 illustrating an exemplary operation employing pipe cleaning assembly 200 in a deepwater environment. The process begins as indicated at block 1105, wherein the pipe cleaning device is inserted into the pipe. Next, as indicated at block 1110, fluid communication is established between the pipe cleaning device and a reservoir. One skilled in the art will understand that there are a wide variety of suitable methods and systems to establish fluid communication between the pipe cleaning device and the reservoir.

Next, as indicated at block 1115, the pipe cleaning device is placed in the first position. As described above, in one embodiment, the first position is configured such that the slide shaft 120 is at or near the extreme forward position along slide shaft 110. Next, as indicated at block 1120, fluid flow is established through a first fluid pathway, wherein the first fluid pathway includes a path from the rear end of the slide shaft to the forward end of the slide shaft.

As described above, in one embodiment, fluid is pumped through the pipe, around the coiled tubing to which the pipe cleaning assembly couples. Additionally, as described above, in one embodiment, fluid passes through the slide shaft fluid pathways, out of the forward ends of the fluid pathways, and onto the inner surface of the pipe and/or blockage. As described above, the fluid and the debris caused by the cleaning action pass through the main shaft inner bore and up through the coiled tube.

Next, as indicated at block 1125, the pipe cleaning device is operated as desired. Next, as indicated at block 1130, the device is placed in a second position. As described above, in one embodiment, the second position is configured such that the slide shaft is at or near the extreme rear position of the main shaft, abutting a retainer. Also as described above, in one embodiment, the second position restricts fluid flow from the forward end of the slide shaft fluid pathways to the rear ends of the slide shaft fluid pathways.

Next, as indicated at block 1135, a fluid flow is established through a second path, where the second path includes a path from the forward end of the slide shaft to the rear end of the slide shaft. As described above, in the second position fluid pumped through the coiled tube passes through the main shaft inner bore and exerts force against the forward cup, which assists in the removal of the pipe cleaning assembly.

Next, as indicated at block 1140, the device is removed from the pipe and the process ends.

Accordingly, the disclosed embodiments provide numerous advantages over other methods and systems. For example, the disclosed embodiments do not depend on an increase or decrease in pressure to reverse direction of the cleaning assembly. Similarly, the disclosed embodiments can be easily and conveniently converted for use in a variety of pipe/open hole diameters. Additionally, the disclosed embodiments allow for full-bore return throughout the tubular pipe/hold. Additionally, the disclosed embodiments are generally less subject to plugging than previous approaches. Similarly, the disclosed embodiments include fewer parts that can break or jam as compared to previous systems and methods.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A pipe cleaning assembly, comprising:
a main shaft defining an inner bore aligned along a first axis, the inner bore being able to couple in fluid communication with coiled tubing;
a slide shaft disposed around the main shaft,
the slide shaft having a forward end, a rear end, and a plurality of fluid pathways,
each of the fluid pathways being in fluid communication between the forward end of the slide shaft and the read end of the slide shaft, and
each of the fluid pathways having a forward end able to direct fluid toward an inner surface of a pipe; and
the slide shaft being able to slide along the main shaft between a first position and a second position, in the direction of the first axis;
the first position being configured to permit fluid flow through the plurality of fluid pathways, from the rear end of the slide shaft to the forward end of the slide shaft; and
the second position being configured to restrict fluid flow through the plurality of fluid pathways, from the forward end of the slide shaft to the rear end of the slide shaft.

2. The pipe cleaning assembly of claim 1, further comprising a cup disposed around the slide shaft, the cup having a flexible outer rim.

3. The pipe cleaning assembly of claim 1, further comprising:
a first cup of a plurality of cups, the first cup being disposed around the slide shaft;
each of plurality of cups having a flexible outer rim; and
each flexible outer rim being configured to make contact with a pipe inner surface, the pipe inner surface having a predetermined diameter.

4. The pipe cleaning assembly of claim 1, further comprising a cup disposed around the slide shaft, the cup having a forward slot, the forward slot configured to seat an o-ring.

5. The pipe cleaning assembly of claim 1, further comprising a cup disposed around the slide shaft, the cup having a rear slot, the rear slot being configured to seat a retaining seal.

6. The pipe cleaning assembly of claim 1, further comprising:
a first cup disposed around the slide shaft;
a second cup disposed around the slide shaft; and
a cup spacer disposed around the slide shaft, the cup spacer being configured to maintain a minimum spacing between the first cup and the second cup.

7. The pipe cleaning assembly of claim 1, further comprising:
a first cup disposed around the slide shaft;
a second cup disposed around the slide shaft; and
a cup spacer disposed around the slide shaft,
the cup spacer being configured to maintain a minimum spacing between the first cup and the second cup, and
the cup spacer having a slot configured to seat an o-ring.

8. The pipe cleaning assembly of claim 1, further comprising:
a retaining nut able to couple to the main shaft; and
the retaining nut being further able to prevent the slide shaft from moving past the first position in the direction away from the second position.

9. The pipe cleaning assembly of claim 1, further comprising:
a retaining nut able to couple to the main shaft, the retaining nut being further able to prevent the slide shaft from moving past the first position in the direction away from the second position;
a blade coupled to the retaining nut; and
the blade being able to break apart matter passing into the forward end of the main shaft inner bore.

10. A method of cleaning a pipe, comprising:
disposing a pipe cleaning assembly within a pipe, the pipe having an inner surface;
the pipe cleaning assembly comprising:
a main shaft defining an inner bore aligned along a first axis, the inner bore being able to couple in fluid communication with coiled tubing;
a slide shaft disposed around the main shaft,
the slide shaft having a forward end, a rear end, and a plurality of fluid pathways,
each of the fluid pathways being in fluid communication between the forward end of the slide shaft and the read end of the slide shaft, and
each of the fluid pathways having a forward end able to direct fluid toward an inner surface of a pipe; and
the slide shaft being able to slide along the main shaft between a first position and a second position, in the direction of the first axis;
the first position being configured to permit fluid flow through the plurality of fluid pathways, from the rear end of the slide shaft to the forward end of the slide shaft; and
the second position being configured to restrict fluid flow through the plurality of fluid pathways, from the forward end of the slide shaft to the rear end of the slide shaft; and
operating the pipe cleaning assembly in the first position to direct fluid flow to the pipe inner surface.

11. The method of claim 10, wherein the pipe cleaning assembly further comprises a cup disposed around the slide shaft, the cup having a flexible outer rim.

13. The method of claim 10, wherein the pipe cleaning assembly further comprises:
a first cup of a plurality of cups, the first cup disposed around the slide shaft;
each of plurality of cups having a flexible outer rim; and
each flexible outer rim being configured to make contact with the pipe inner surface, the pipe inner surface having a predetermined diameter.

14. The method of claim 10, wherein the pipe cleaning assembly further comprises a cup disposed around the slide shaft, the cup having a forward slot, the forward slot being configured to seat an o-ring.

15. The method of claim 10, wherein the pipe cleaning assembly further comprises a cup disposed around the slide shaft, the cup having a rear slot, the rear slot being configured to seat a retaining seal.

16. The method of claim 10, wherein the pipe cleaning assembly further comprises:
a first cup disposed around the slide shaft;
a second cup disposed around the slide shaft; and
a cup spacer disposed around the slide shaft, the cup spacer being configured to maintain a minimum spacing between the first cup and the second cup.

17. The method of claim 10, wherein the pipe cleaning assembly further comprises:
a first cup disposed around the slide shaft;
a second cup disposed around the slide shaft; and
a cup spacer disposed around the slide shaft,
the cup spacer being configured to maintain a minimum spacing between the first cup and the second cup, and
the cup spacer having a slot configured to seat an o-ring.

18. The method of claim 10, wherein the pipe cleaning assembly further comprises:
a retaining nut able to couple to the main shaft; and
the retaining nut further able to prevent the slide shaft from moving past the first position in the direction away from the second position.

19. The method of claim 10, wherein the pipe cleaning assembly further comprises:
a retaining nut able to couple to the main shaft, the retaining nut further being able to prevent the slide shaft from moving past the first position in the direction away from the second position;
a blade coupled to the retaining nut; and
the blade being able to break apart matter passing into the forward end of the main shaft inner bore.
